(19) United States
(12) Patent Application Publication
(10) Pub. No.: US 2025/0104536 A1
(43) Pub. Date: Mar. 27, 2025

(54) GAMING SYSTEM AND METHOD WITH A MULTIPLYING SYMBOL FEATURE

(71) Applicant: LNW Gaming, Inc., Las Vegas, NV (US)

(72) Inventors: Richard MILOSEVICH, Las Vegas, NV (US); George BOUVIER, Henderson, NV (US)

(21) Appl. No.: 18/894,056

(22) Filed: Sep. 24, 2024

Related U.S. Application Data
(60) Provisional application No. 63/585,788, filed on Sep. 27, 2023.

(51) Int. Cl. G07F 17/34; G07F 17/32

(52) U.S. Cl. CPC G07F 17/34; G07F 17/3213; G07F 17/3267

(57) ABSTRACT

Disclosed are a gaming machine and method that utilize game-logic circuitry and a presentation assembly configured to present a plurality of symbol-bearing reels and an array, each location of the array including a multiplier. The symbols include multiplier modification symbols, value-bearing symbols and catalyst symbols. The reels are spun and stopped to land symbols from the reels in the array. The multiplier of each location that receives a multiplier modification symbol is modified. The value borne by each value-bearing symbol that landed in the array is then multiplied by the multiplier at its respective location. In response to the reel spin outcome including at least one value-bearing symbol and at least one catalyst symbol, a determined number of the values borne by a randomly selected set of the value-bearing symbols present in the array are sequentially collected in an animated fashion and the sum of the collected values is awarded.

### RELATED APPLICATIONS

This patent application claims the benefit of U.S. Provisional Patent Application No. 63/585,788 filed Sep. 27, 2023, which is incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023, LNW Gaming, Inc.

### FIELD OF THE INVENTION

The present invention relates to a technological improvement to gaming systems, gaming machines, and methods and, more particularly, to technological improvements in connection with a multiplying symbol feature.

### BACKGROUND OF THE INVENTION

The gaming industry depends upon player participation. Players are generally “hopeful” players who either think they are lucky or at least think they can get lucky-for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple game features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

Disclosed are a gaming machine and method that utilize game-logic circuitry and a presentation assembly configured to present a plurality of symbol-bearing reels and an array, each location of the array including a multiplier. The symbols include multiplier modification symbols, value-bearing symbols and catalyst symbols. The reels are spun and stopped to land symbols from the reels in the array. The multiplier of each location that receives a multiplier modification symbol is modified. The value borne by each value-bearing symbol that landed in the array is then multiplied by the multiplier at its respective location. In response to the reel spin outcome including at least one value-bearing symbol and at least one catalyst symbol, a determined number of the values borne by a randomly selected set of the value-bearing symbols present in the array are sequentially collected in an animated fashion and the sum of the collected values is awarded.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a front view of a free-standing gaming machine according to an embodiment of the present invention.

FIG. 2 is a block diagram of a gaming system according to an embodiment of the present invention.

FIGS. 3, 4, 5A, 5B, 6A and 6B are exemplary presentations of reel spin outcomes in accordance with one or more embodiments.

FIGS. 7A, 7B and 7C are a flow diagram for a data processing method that corresponds to instructions executed by a controller, according to an embodiment of the present invention. FIG. 7A relates to a base game portion of the method; FIG. 7B relates to the application of one or more special symbols and FIG. 7C relates to a bonus game in accordance with one or more embodiments.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

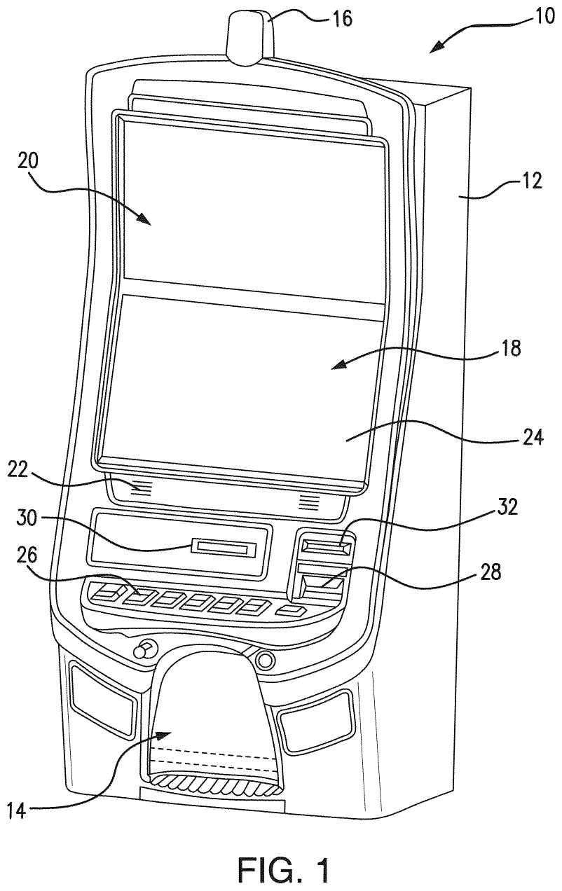

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls, and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

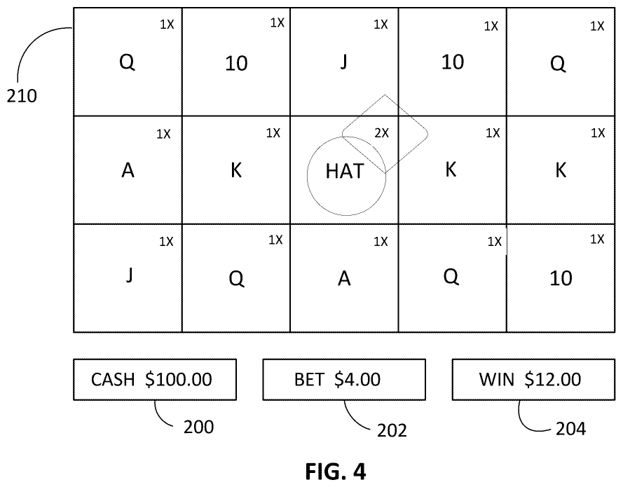

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (see FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

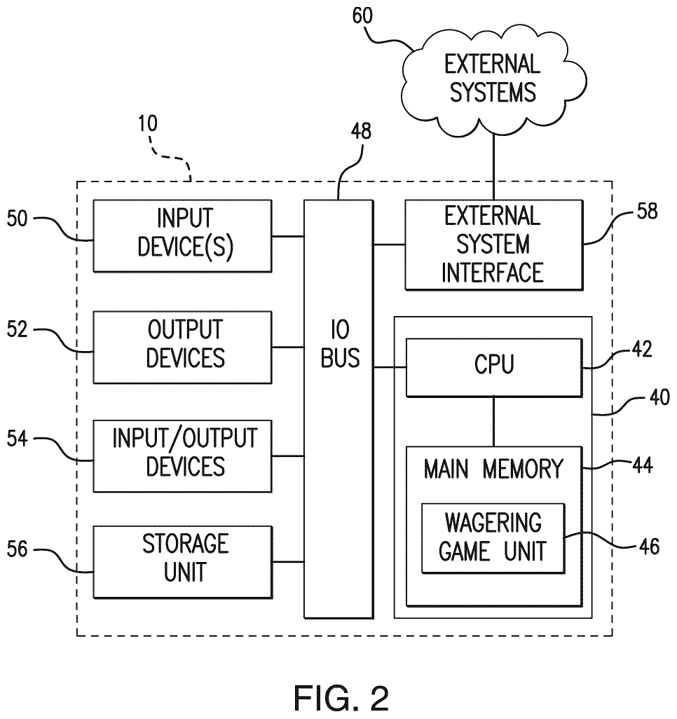

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accordance with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

The game-logic circuitry controls one or more presentation devices (e.g., mechanical-reel display device, video display device, or a combination thereof) to present a plurality of symbol-bearing reels and an array of symbol positions. Although the method is described with respect to one presentation device, it is to be understood that the presentation described herein may be performed by a presentation assembly including more than one presentation device. The symbol positions of the array may be arranged in a variety of configurations, formats, or structures and may comprise a plurality of rows and columns. The rows of the array are oriented in a generally horizontal direction, and the columns of the array are oriented in a generally vertical direction. The symbol positions in each row of the array are horizontally aligned with each other, and the symbol positions in each column of the array are vertically aligned with each other. Alternatively, the symbol positions may be arranged in a honeycomb configuration with adjacent columns vertically offset from each other by one-half symbol position or adjacent rows horizontally offset from each other by one-half symbol position. The number of symbol positions in different rows and/or different columns may vary from each other. The reels may be associated with the respective columns of the array such that the reels spin vertically, and each reel populates a respective column. In another embodiment, the reels may be associated with the respective rows of the array such that the reels spin horizontally, and each reel populates a respective row. In some embodiments, the reels are associated with respective individual symbol positions of the array such that each reel animates in place and populates only its respective symbol position. The symbol array configuration may vary between the base game and any bonus games utilizing the array.

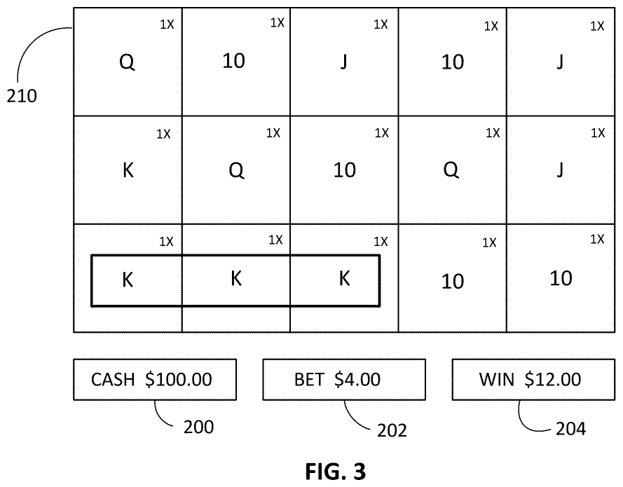

FIG. 3 illustrates an example of the symbol array 210 with a three-by-five rectangular configuration with each symbol position associated with a respective independent reel. Additionally, each symbol position in the array 210 is assigned a multiplier value, initially set to 1×. In the example of FIG. 3, this multiplier is displayed in the upper right corner of each symbol position in the array 210. In some embodiments, the multiplier associated with an array location is only displayed if it has been set to a value greater than 1×, as explained further below.

The locations in the array 210 illustrated in FIG. 3 represent the outcome of a first representative reel spin, highlighting that the reels bear a plurality of symbols that include various standard game symbols such as 10, J, Q, K, A. The reels also bear other special symbols, however none of those special symbols landed in the array 210 in the reel spin outcome of FIG. 3

A first kind of special symbol is the HAT symbol. FIG. 4 illustrates an example of the display at the conclusion of a second representative base game spin in which a HAT symbol landed in array 210. HAT symbols modify the multiplier associated with array position in which they land. As described above, each symbol position in the array 210 is assigned a multiplier value, initially set to 1×. In response to a HAT symbol landing in the array 210, the multiplier associated with the location in which the HAT symbol landed is modified, for example, incremented by 1 from 1× to 2×. The new multiplier is maintained from spin to spin until it is reset, as will be described later.

In the example of FIG. 4, because a HAT symbol landed in the center position of the array 210, the multiplier associated with that position increased from 1× to 2×. Incrementation of the multiplier is only one example of how a HAT symbol may modify a multiplier. For example, each landing of a HAT symbol in a given location may multiply the multiplier by two, from 1× to 2× or from 2× to 4×, etc. In accordance with still other embodiments, each HAT symbol may bear a designated modification rule, for example, one HAT symbol may bear a +1× rule while another HAT symbol might bear a +2× rule. In still other embodiments, the modification rule applied to a given location may be randomly determined.

The modification of the multiplier may be highlighted or animated. As an example, the animation in FIG. 4 is represented by a diamond shape surrounding the 2× multiplier, however, any animation such as flashing, bolding or a color change as examples, falls within the spirit and scope of the invention. The new multiplier will remain in place from spin to spin until reset to 1×, as described below.

In accordance with some embodiments, if a multiplier has already reached a maximum value on a previous spin, it will not be further modified when a HAT symbol lands in its corresponding location. In other embodiments, the number of multiplier modifications is not limited.

A second kind of special symbol borne by the reel is a BAT symbol. BAT symbols are value-bearing symbols emblazoned with credit values or other prize indications, such as labels for progressive awards. These value-bearing symbols are often known as “WYSYWIG” or “What You See is What You Get” symbols. In some embodiments, as soon as a BAT symbol lands in the array, the value borne by the BAT symbol is awarded. However, in the embodiments described here, the values borne by the BAT symbols only represent potential prize values, awarded in response to a triggering condition, an example of which will be described below.

BAT symbols may also provide their own triggering condition for other game functionality. For example, in normal game play, the appearance of a certain number of BAT symbols in the array 210 may trigger the start of a bonus game.

When BAT symbols land in the array 210, their values may be modified by the multiplier associated with the location in which they land.

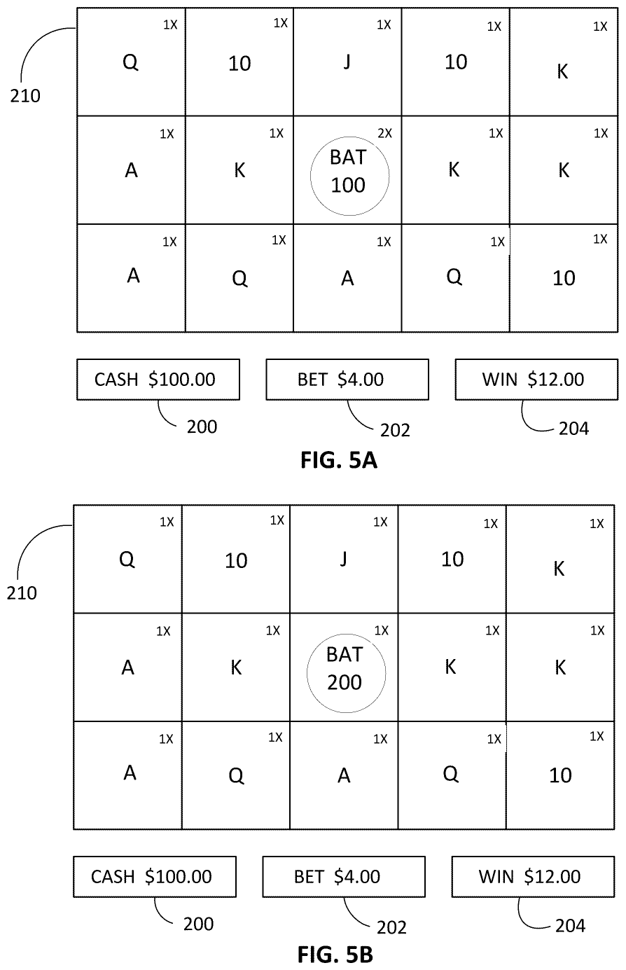

FIG. 5A represents the outcome of a third representative game spin in which a single BAT symbol landed in the center location of the array 210. Because the multiplier at this location was previously modified to 2× when a HAT symbol landed in that location in a previous spin (FIG. 4), the 100-credit value borne by the landed BAT symbol will increase to 200 credits. The multiplier, once applied to the BAT symbol, will be reset to 1×.

FIG. 5B illustrates these modifications to the outcome of the third representative game spin. Though no additional BAT symbols landed in the array in this example, in other spin outcomes, the process of applying its associated multiplier is replicated for each landed BAT symbol. Though not shown, the application of each multiplier to a BAT symbol may be animated or highlighted by flashing, color changes, audio events, etc.

The third kind of special symbol is the CAT symbol. CAT symbols serve as a “catalyst” or trigger for an award based on a collection of values from BAT symbols in the array 210. (If there are no BAT symbols in the array 210, a landed CAT symbol has no effect.)

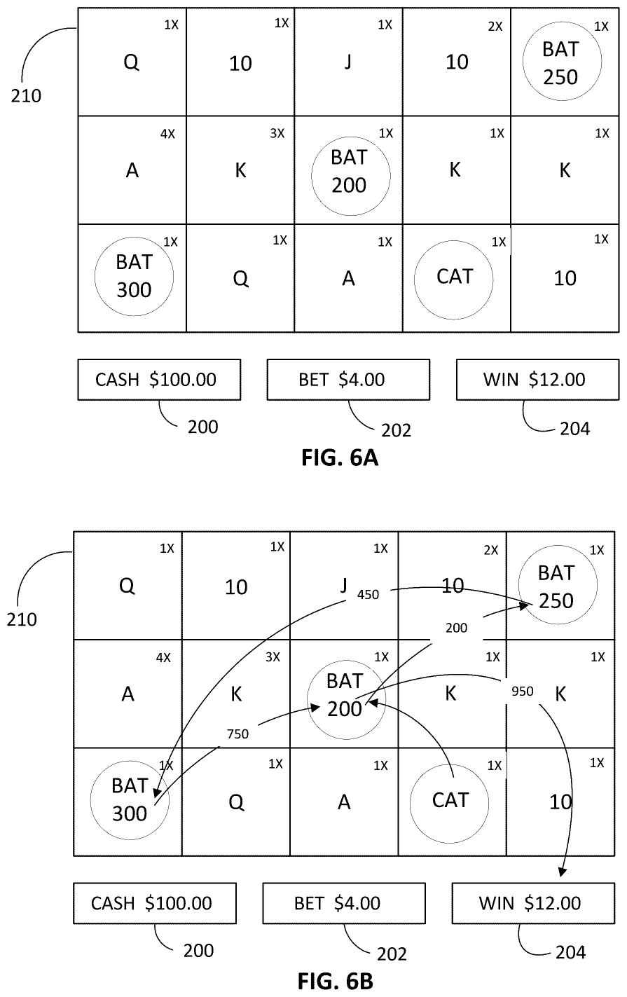

As an example, FIG. 6A illustrates the results of a fourth representative game spin in which a single CAT symbol and three BAT symbols landed in the array 210. The CAT symbol triggers a collection of values borne by the BAT symbols currently in the array 210. Via the RNG, the game-logic circuitry selects a random number and then, in sequence, the game-logic circuitry presents an animation sequence of collecting values borne by the randomly determined number of BAT symbols into an award. In alternate embodiments, the determined number of BAT symbols is a fixed predetermined number, for example, three.

FIG. 6B provides an example of this animation, with arrows representing a randomly determined collection path from BAT symbol to BAT symbol. A progressively accumulating award is shown on each of the lines, starting with 200 credits as the sequence moves from the BAT symbol at the center symbol location to the BAT symbol in the upper right corner, where it adds 250 to the award for a new total of 450, then on to the BAT symbol in the lower left corner, where it adds an additional 300 credits to the award for a new total of 750, then on to the BAT in the center location to accumulate an additional 200 credits for a final award total of 950 credits, which is then shown being passed on to the win meter 204. It should be noted that a particular BAT symbol may be selected more than once. In this example, the game-logic circuitry randomly chose to collect values from four BAT symbols and collected from the center symbol twice.

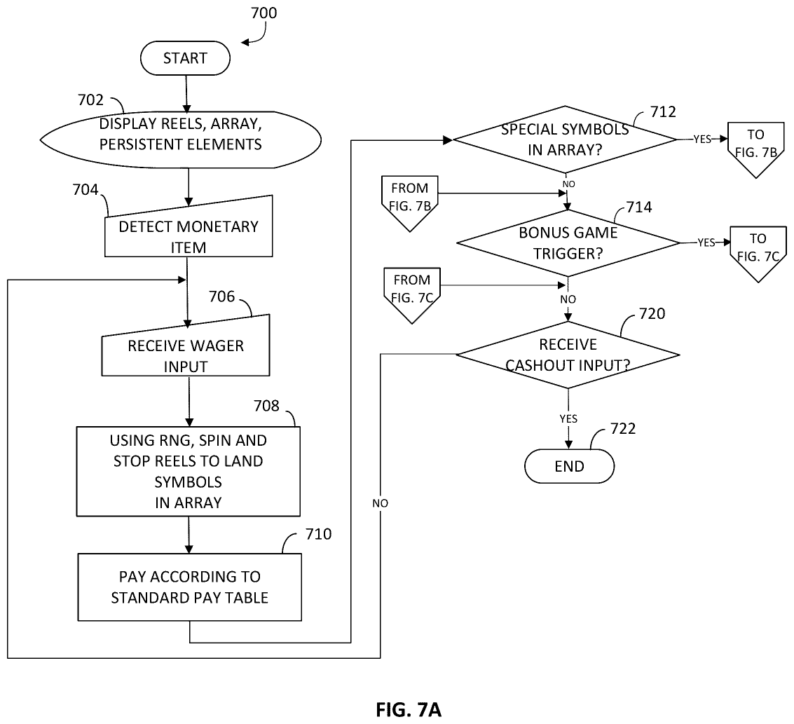

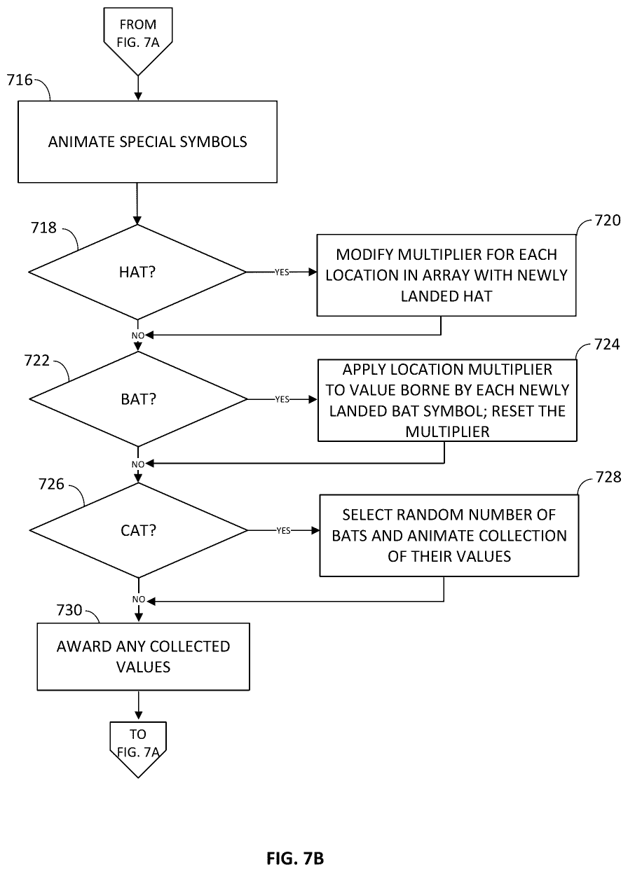

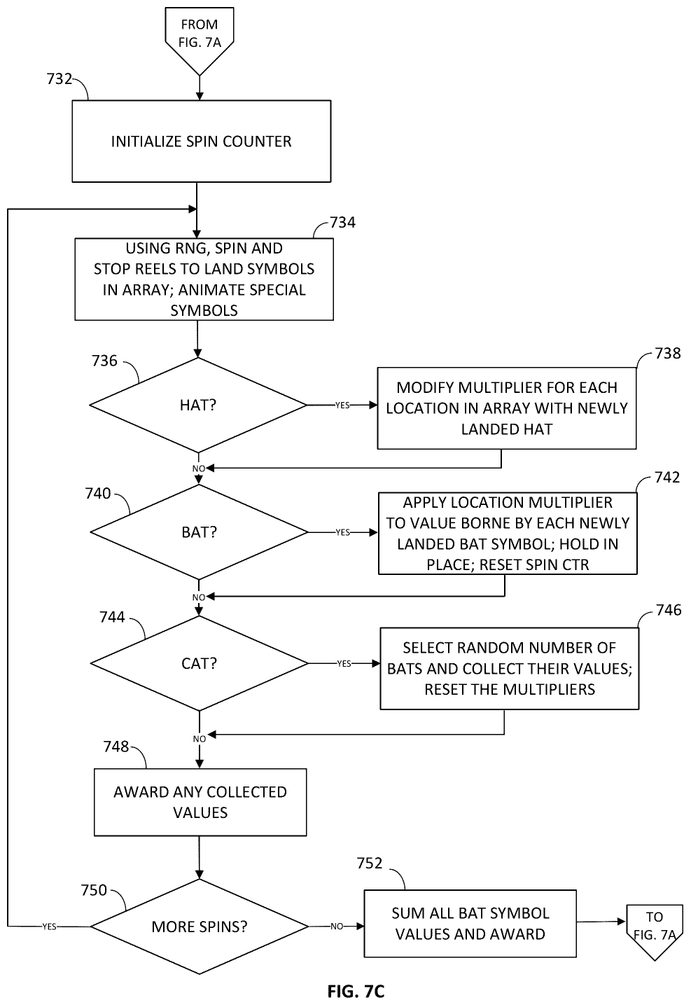

Referring now to FIGS. 7A-7C, there is shown a flow diagram representing one data processing method corresponding to at least some instructions stored and executed by the game-logic circuitry 40 in FIG. 2 to perform operations according to an embodiment of the present invention. The data processing method is described below in connection with the exemplary presentations of the different spin outcomes in FIGS. 3, 4, 5A and 6A.

### Game Play Initiation

Referring to FIG. 7A, the data processing method commences at step 700.

At step 702, the game-logic circuitry controls the one or more presentation devices (e.g., mechanical-reel display device, video display device, or a combination thereof) to present a plurality of symbol-bearing reels and an array of symbol positions as described above.

At step 704, the game-logic circuitry detects, via a value input device, a physical item associated with a monetary value that establishes a monetary balance in the form of cash or credits. In FIG. 3 and the other examples of spin outcomes, the monetary balance may be shown on a meter 200.

### Game Spin

At step 706, the game-logic circuitry initiates a game of a wagering game cycle (i.e., spin cycle) in response to an input indicative of a wager covered by the monetary balance. To initiate a spin of the reels, the player may press a “Spin” or “Max Bet” key on a button panel or touch screen. In FIG. 3 and the other examples of spin outcomes, the wager may be shown on a bet meter 202.

At step 708, using an RNG, the game-logic circuitry spins and stops the reels to randomly land symbols from the reels in the array in visual association with one or more paylines (also known as lines, ways, patterns, or arrangements). The reel spin may be animated on a video display by depicting symbol-bearing strips moving vertically across the display and synchronously updating the symbols visible on each strip as the strip moves across the display (FIGS. 3, 4, 5A, 6A).

At step 710, the game-logic circuitry evaluates the patterns of standard symbols landed in the array. Payouts are awarded in accordance with a pay table. The pay table may, for example, include “line pays,” “ways pays” and “scatter pays.” Line pays occur when a predetermined type and number of symbols appear along an activated payline, typically in a particular order such as left to right, right to left, top to bottom, bottom to top, etc. Ways pays appear on adjacent reels without the requirement to be on a specified pay line or directly adjacent to one another. Scatter pays occur when a predetermined type and number of symbols appear anywhere in the displayed array without regard to position or paylines. Each payline preferably consists of a single symbol position in each column of the array. The number of paylines may be as few as one or as many as possible given each payline consists of a single symbol position in each column of the array. To animate a standard pay, the display may apply a border, pattern, color change, background change, watermark, or other distinguishing characteristic to the winning payline and/or winning symbols that contributed to the pay. In the example of FIG. 3, which illustrates a game spin outcome in which only standard symbols landed in the array 210, a line pay of three K symbols in the bottom row of the array 210 occurred. The awarded pay is added to a win meter 204 (FIG. 3). The process continues until all winning combinations of standard symbols have been awarded at step 710.

The plurality of symbols on the reels may also include special symbols: value-bearing symbols, multiplier modification symbols and catalyst symbols. For the sake of convenience, the illustrations and examples shown here represent the value-bearing symbols as BAT symbols, the multiplier modification symbols as HAT symbols and the catalyst symbols as CAT symbols. It will be obvious to those skilled in the art that any symbol designation or representation may be assigned to each of the special symbols with the functionalities described herein.

At step 712, the game-logic circuitry determines whether or not any of the special BAT, HAT or CAT symbols landed in the array 210 and, if not, flow proceeds to step 714. If, however, at step 310, the game-logic circuitry determines that at least one special symbol landed in the array, flow proceeds to step 716 of FIG. 7B, described next.

### The Landing of Special Symbols

Individual or combinations of landed special symbols are evaluated differently than the evaluation of standard symbols described above with respect to step 710. Each of the special symbols may trigger additional functionality when it lands in the array 210. At step 716, the game-logic circuitry may emphasize, via the one or more presentation devices, the landing of any special symbol in the array. This may include flashing or otherwise animating or highlighting the landed special symbols.

At step 718, if no HAT symbols landed in the array 210, flow proceeds directly to step 722. However, if at least one HAT symbol landed in the array 210, the game logic circuitry proceeds to step 720 and modifies the multiplier associated with each location in the array 210 in which a HAT symbol landed as described above with reference to FIG. 4.

At step 722, if no BAT symbols landed in the array 210, flow proceeds directly to step 726. However, if at least one BAT symbol landed in the array 210, an example of which is shown in FIG. 5A, the game-logic circuitry proceeds to step 724 and applies the multiplier associated with each location in the array 210 in which a BAT symbol landed to the value borne by each respective landed BAT symbol. The values are not awarded, just modified in place on the BAT symbol(s), as described above with reference to FIG. 5B. Once applied to each BAT symbol, its respective multiplier is reset to 1×.

At step 726, if no CAT symbols landed in the array 210, flow proceeds directly to step 730. However, if at least one CAT symbol landed in the array 210, an example of which is shown in FIG. 6A, the game-logic circuitry proceeds to step 728.

At step 728, a random number of BAT symbols is determined and the values of the determined number of BAT symbols are collected in animated sequence as described above with reference to FIG. 6B.

At step 730, if no CAT catalyst symbols landed in the array 210 and no values were collected from BAT symbols, no award is paid. Any multipliers modified at step 720 that were not reset by landed BAT symbols remain modified and will be in effect for the next game spin.

If, however, at step 730, at least one CAT symbol landed in the array and values were collected, the collected values are awarded at step 730, with the awarded value being added to the win meter 204.

In either case, flow returns to FIG. 7A, step 714.

### Bonus Game Initiation

At step 714, the game-logic circuitry determines whether a triggering event for a bonus game has occurred. Any bonus game triggering event such as a “mystery trigger,” a certain combination of symbols landing in the array 210, a predetermined number of games elapsed without the triggering of a bonus game, etc. all fall within the spirit and scope of the invention. In some embodiments, the landing of six or more BAT symbols in the array 210 triggers a bonus game at step 714.

If a bonus game has not been triggered at step 714, flow continues to step 716, otherwise flow continues to step 732 of FIG. 7C, which will be described next.

At step 732, a bonus game is initiated by initiating a spin counter to a certain number of free spins, for example, three free spins. In some embodiments, the number of free spins is predetermined. In other embodiments, the number of free spins may be randomly determined and vary between each awarding of free spins. The free spins described here are played as a “hold and spin” game in which BAT symbols, once landed in the array, are held in place for the duration of the bonus game. In accordance with one or more embodiments, the reels used in the bonus spins are special reels bearing only HAT, BAT and CAT symbols. In other embodiments, the reels may include the standard symbols and remain unchanged from the base game, however, the standard symbols are not included for win evaluation purposes. In still other embodiments, the free games are evaluated the same as the base game, the only difference being that CAT symbols are held from spin to spin. In other embodiments, the free games are evaluated the same as the base game and CAT symbols are not held; the only difference between the bonus game and the base game is that no wager is required during the bonus game. In the preferred embodiment, all multipliers in the array may be reset to 1× at the start of the bonus game and, at the conclusion of the bonus game, be restored to their values prior to initiation of the bonus game. However, other embodiments carry over any pre-existing multipliers into the bonus game.

### The Landing of Special Symbols in the Bonus Game

At step 734, using an RNG, the game-logic circuitry spins and stops the reels to randomly land symbols from the reels in the array as step 708. The game-logic circuitry may emphasize, via the one or more presentation devices, the landing of any special symbol in the array. This may include flashing or otherwise animating or highlighting the landed special symbols as in step 716.

At step 736, if no HAT symbols landed in the array 210, flow proceeds directly to step 740. However, if at least one HAT symbol landed in the array 210, the game logic circuitry proceeds to step 738 and modifies the multiplier associated with each location in the array 210 in which a HAT symbol landed as described above with reference to step 720 and FIG. 4.

At step 740, if no BAT symbols landed in the array 210, flow proceeds directly to step 744. However, if at least one BAT symbol landed in the array 210, an example of which is shown in FIG. 5A, the game-logic circuitry proceeds to step 742 and applies the multiplier associated with each location in the array 210 in which a BAT symbol landed to the value borne by each respective landed BAT symbol. The values are not awarded, just modified in place on the BAT symbol(s), as described above with reference to step 724 and FIG. 5B. The bonus game may be extended with the number of free spins reset to their initial value, for example, three free spins, or to some other value. For example, the number of free spins remaining on the spin counter may be increased by a predetermined or random amount for each BAT symbol as it lands or for a predetermined total number of BAT symbols present in the array 210.

At step 744, if no CAT symbols landed in the array 210, flow proceeds directly to step 748. However, if at least one CAT symbol landed in the array 210, an example of which is shown in FIG. 6A, the game-logic circuitry proceeds to step 746.

At step 746, a random number of BAT symbols is determined and the values of the determined number of BAT symbols are collected as described above with reference to step 728 and FIG. 6B.

At step 748, if no CAT catalyst symbols landed in the array 210 and no values were collected from BAT symbols, no action is taken, however, any multipliers modified at step 738 remain modified and will be in effect for the next bonus game spin. In the preferred embodiment, any BAT symbols in the array 210 will be held in place for any remaining bonus spins and will not be replaced by any return to step 734. If, however, at least one CAT symbol landed in the array and values were collected, the collected values are awarded at step 748, with the awarded value being added to the win meter 204. The BAT symbols remain in place in the array 210 and maintain their values.

### Bonus Game Termination

At step 750, the game-logic circuitry may modify the bonus spin counter, for example, by subtracting one from the number of remaining bonus mode spins prior to testing for bonus game termination. If more spins remain, flow returns to step 734 for another free spin. Otherwise, at step 752, the values borne by all BAT symbols that have landed and been held in the array are summed and awarded. Flow then returns to FIG. 3A, step 720.

### Game Play Continuation/Termination

At step 720, the game-logic circuitry determines whether or not it has received a cashout input via at least one of the one or more player input devices of the gaming machine. If it has not received a cashout input, the game-logic circuitry waits for the next wager input at step 706. If it has received a cashout input, the game-logic circuitry initiates a payout from the monetary balance on the meter 200. The data processing method then ends at step 722.

The recitations of a value input device for establishing a credit balance, an input device for accepting a wager input that initiates a spin, and a value output device for paying out the credit balance are integrally incorporated within the steps of the data processing method. For example, the presentation of game outcomes through the spinning and stopping of the reels is essential to the game outcome determinations, which may only be initiated by the accepted wager input. Furthermore, a value input device for establishing a credit balance, an input device for accepting a wager that initiates a spin, and a value output device for paying out the credit balance are physical, structural elements that are not shared by generic or well-known computing devices but, rather, are particular to gaming machines.

Embodiments of the present invention realize benefits in increased computer processing efficiency with minimized processing overhead, fewer rules to be evaluated, fewer player inputs to be monitored, and simpler graphical representations. Some embodiments of the present invention comprise an innovative application of data processing steps that, when implemented by game-logic circuitry, direct a presentation assembly to present a symbol-value collection, selection, and award process that minimizes processing overhead by utilizing numbered indicia to represent credit values instead of complex, fanciful game images. In this way, these value]-bearing symbols require fewer rules needed for the award process than would be necessary for calculating values of winning symbol combinations enumerated in stored pay tables, as found in more complex reel-spinning routines. At the same time, embodiments of the present invention provide a straightforward, what-you-see-is-what-you-get (WYSIWYG) visual presentation that is simple to understand and, therefore, effective in generating player excitement and enthusiasm. The result is a highly flexible value-award process that can be easily adapted to any theme/brand while remaining easily understood by players.

While the above examples have a multiplier for each array location, other modifiable properties are possible. For example, each array location might have an associated number of credits to be added to a landed BAT symbol and the above-described multiplication modifiers symbols (HAT symbols) would then be considered adder modification symbols.

In some embodiments, a mix of multiplier and adder properties in the array 210 is possible, with some locations having associated multipliers and some having associated adders. In these cases, if a multiplier-specific HAT symbol lands in a location with an associated adder, it would have no effect, however, a multiplier-specific HAT symbol landing in a location with an associated multiplier would modify the multiplier as described above. Similarly, a landed adder-specific HAT symbol would only impact an adder at its landed location in the array 210.

In still other embodiments, each array location might have multiple associated modifier properties, for example, an associated multiplier and an associated adder. When a HAT symbol of a particular type landed in a given location, the property associated with the landed HAT would be modified. When a later BAT landed in a given location, one or both modifier properties would then be applied to the value borne by the BAT symbol and the properties would be reset (or not) as described above. Various combinations of these concepts all fall within the spirit and scope of the invention.

In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of operating a gaming machine, the method comprising the operations of:
presenting, by a presentation assembly, a plurality of symbol-bearing reels and an array, each location in the array comprising an associated multiplier,
spinning and stopping the plurality of reels to land symbols from the reels in the array to produce a reel spin outcome; and
in response to the landed symbols of the reel spin outcome including at least one multiplier modification symbol, animating modification of the multiplier associated with each location in the array in which a multiplier modification symbol landed;
in response to the landed symbols of the reel spin outcome including at least one value-bearing symbol, animating multiplication of the value borne by the landed value-bearing symbol by the multiplier associated with the respective position in the array in which the value-bearing symbol landed;
in response to the landed symbols of the reel spin outcome including at least one catalyst symbol and at least one value-bearing symbol, animating collection of a determined number of values borne by a randomly chosen selection of value-bearing symbols present in the array; and
receiving, via at least one of one or more electronic input devices, a cash out input that initiates a payout from the monetary balance via a value output device.

2. The method of claim 1, wherein the determined number is a predetermined fixed number.

3. The method of claim 1, wherein the determined number is randomly determined.

4. The method of claim 1, wherein the selection of value-bearing symbols comprises selecting a given value-bearing symbol more than once.

5. The method of claim 1, wherein the modification of the multiplier comprises incrementing the multiplier by one.

6. The method of claim 1, wherein the modification of the multiplier comprises modifying the multiplier based on modification rule borne by the multiplier modification symbol.

7. The method of claim 1, wherein the modification of the multiplier is randomly determined.

8. The method of claim 1, wherein the reel spin outcome is a result of a spin initiated in response to a wager.

9. The method of claim 1, wherein the reel spin outcome is the result of one of a series of free spins.

10. The method of claim 9, wherein landing of a value-bearing symbol as part of the reel spin outcome increases the number of free spins in the series of free spins.

11. A gaming machine comprising:
a presentation assembly;
a value input device configured to accept a physical item associated with a monetary value to establish a credit balance;
a value output device configured to dispense a payout from the credit balance in response to a cashout input; and
game-logic circuitry configured to perform the operations of:
presenting, by a presentation assembly, a plurality of symbol-bearing reels and an array, each location in the array comprising an associated multiplier,
spinning and stopping the plurality of reels to land symbols from the reels in the array to produce a reel spin outcome; and
in response to the landed symbols of the reel spin outcome including at least one multiplier modification symbol, animating modification of the multiplier associated with each location in the array in which a multiplier modification symbol landed;
in response to the landed symbols of the reel spin outcome including at least one value-bearing symbol, animating multiplication of the value borne by each landed value-bearing symbol by the multiplier associated with the respective position in the array in which a value-bearing symbol landed;
in response to the landed symbols of the reel spin outcome including at least one catalyst symbol and at least one value-bearing symbol, animating collection of a determined number of values borne by a randomly chosen selection of value-bearing symbols present in the array; and
receiving, via at least one of one or more electronic input devices, a cash out input that initiates a payout from the monetary balance via a value output device.

12. The gaming machine of claim 11, wherein the determined number is a predetermined fixed number.

13. The gaming machine of claim 11, wherein the determined number is randomly determined.

14. The gaming machine of claim 11, wherein the selection of value-bearing symbols comprises selecting a given value-bearing symbol more than once.

15. The gaming machine of claim 11, wherein the modification of the multiplier comprises incrementing the multiplier by one.

16. The gaming machine of claim 11, wherein the modification of the multiplier comprises modifying the multiplier based on modification rule borne by the multiplier modification symbol.

17. The gaming machine of claim 11, wherein the modification of the multiplier is randomly determined.

18. The gaming machine of claim 11, wherein the reel spin outcome is a result of a spin initiated in response to a wager.

19. The gaming machine of claim 11, wherein the reel spin outcome is the result of one of a series of free spins.

20. The gaming machine of claim 19, wherein landing of a value-bearing symbol as part of the reel spin outcome increases the number of free spins in the series of free spins.
